(19) United States
(12) Patent Application Publication
(10) Pub. No.: US 2009/0035046 A1
(43) Pub. Date: Feb. 5, 2009

(54) Print drum

(76) Inventors: Jason S. Belbey, Vancouver, WA (US); Steven P. Downing, Vancouver, WA (US); Stuart D. Spencer, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,144

(22) Filed: Jul. 31, 2007

(51) Int. Cl. B41J 13/02

(52) U.S. Cl. 400/630

(57) ABSTRACT

A print drum for carrying sheets of media during printing, including a rotatable carrier drum generally defining an outer cylindrical boundary about a drum axis, and at least one media control member extending laterally substantially parallel to the carrier drum axis. The media control member is controllably movable between (1) a first position extending beyond the carrier drum boundary to define a lateral alignment barrier for a leading edge of a media sheet when adding the media sheet to the carrier drum, (2) a second position beneath the outer cylindrical boundary when printing on the added media sheet, and (3) a third position projecting outwardly of the outer cylindrical boundary to push the leading edge of the added sheet of media away from the outer cylindrical boundary.

### BACKGROUND

Drum printing processes have been used in which media such as paper is advanced through a printing device, with printing occurring on the media as it moves past a print area (such as with contact printing). Such printing may occur with continuous sheets of media, which are then cut and suitably handled for distribution such as in the newspaper industry, drum printing has also been used for printing on individual sheets of media.

It should be appreciated that when printing is being done on many individual sheets of media, achieving desired high speeds of printing can depend not only on the speed capabilities of the printing device, but also the ability to reliably and accurately transfer media sheets onto the drum at high speeds. Such transfer requires not only that media sheets be added to the drum at high speeds, but also that the media sheets be precisely and accurately aligned on the drum. Further, transfer requires that the media sheets be reliably removed from the drum after printing is completed, without damaging the media sheets in the process.

Proper alignment of the media sheets has been sought by a variety of methods, including precise media feeders and slowing down the drum rotation speed (including reversing the direction of rotation of the drum).

Removal of the media sheets from the drum has been accomplished, for example, by scraping the media sheets off, with the outer face of the media sheets contacted by a member to pull them from the drum (or “back press roller”). U.S. Pat. No. 5,553,543 discloses a device which may be used with a print drum for mounting the leading edge of a print sheet, and includes a separate device which lifts the leading edge of the print sheet when it is released after printing.

### DESCRIPTION OF THE DRAWINGS

Features of exemplary embodiments will become apparent from the description, the claims, and the accompanying drawings in which:

FIG. 1 is a schematic representation of one embodiment of the present invention, having a printing device including a print drum which aligns and moves sheets of media during the printing process.

FIG. 2 is a perspective view of a portion of the print drum of the embodiment of FIG. 1 and illustrates the media control member of the print drum in a media aligning position.

FIG. 3 is a cross sectional view of the print drum and media control member in the media aligning position of FIG. 2.

FIG. 4 is a perspective view of a portion of the print drum of the embodiment of FIG. 1 and illustrates the media control member of the print drum in a media securing position.

FIG. 5 is a cross sectional view of the print drum and media control member in the media securing position of FIG. 4.

FIG. 6 is a perspective view of a portion of the print drum of the embodiment of FIG. 1 and illustrates the media control member of the print drum in a media ejecting position.

FIG. 7 is a cross sectional view of the print drum and media control member in the media ejecting position of FIG. 6.

FIG. 8 is a perspective view of a portion of a print drum of a second embodiment of the present invention, and illustrates the media control member of the print drum in a media aligning position.

FIG. 9 is an end view of the print drum of the embodiment of FIG. 8, and illustrates the position of a plurality of media control members and their position actuator.

FIGS. 10-12 are end views of the print drum of the embodiment of FIG. 8 illustrating different positions of the actuator and media control member, sequentially showing the media control member in its retracted position (FIG. 10), aligning position (FIG. 11) and ejecting position (FIG. 12).

### DETAILED DESCRIPTION

Referring to the BACKGROUND section above, it should be appreciated that the referenced methods of aligning the media sheets (e.g., paper sheets) can increase the cost of the machine and add complexity and wear to components over the life of the machine (and thereby increase maintenance costs and down time), as well as decreasing the effective print speed (as reflected in the number of sheets printed per minute). Further, removal of the media sheets by scraping them from the drum requires that a scraper be positioned against the drum to contact the leading edge of the media sheet to lift it off the drum as it is moved past the scraper. Such a scraper risks jamming and/or damaging the leading edge of the media sheet if the scraping member is not sharp enough, or positioned close enough to the drum. Also, there is a risk of damaging and/or wearing the surface of the drum due to contact with the scraper, which can require the use of special (more expensive) materials in making the drum to prevent such wear and damage. Moreover, while mentioned U.S. Pat. No. 5,553,543 discloses a device which may allow media sheet removal without scraping its outer face, it does so via a separate mechanism from that used to secure the media sheets on the drum, and that device does not appear to address the alignment issues when mounting the media sheets.

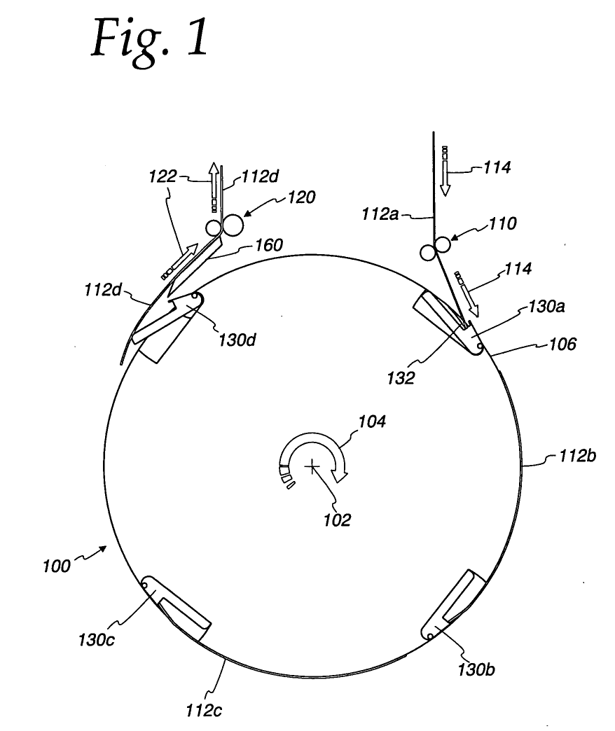

Turning to FIG. 1, an embodiment of a drum 100 incorporating various aspects of the present invention is shown, with the drum 100 being suitably mountable and driven for rotation about an axis 102 in the direction of the arrow 104. The drum 100 defines an outer cylindrical boundary 106 around the axis 102.

A suitable media sheet feed 110 is provided to supply individual media sheets 112 in the direction of the arrows 114. Each media sheet 112a is fed so that the leading edge of the sheet 112a travels at a rate of speed which is slightly higher than the tangential rate of speed of the drum 100 at its outer cylindrical boundary 106.

A suitable media sheet take-away 120 is also provided to take away media sheets 112d in the direction of the arrows 122 after printing on the sheets has been completed.

In the embodiment illustrated in FIG. 1, four media control members 130 are provided around the drum 100, with suitable actuators provided to control the position of the media control members 130 between different positions according to the position of the drum 100.

In the FIG. 1 illustration, one media control member 130a (adjacent the media sheet feed 110) is in a first position extending beyond the drum cylindrical boundary 106 to define a lateral alignment barrier 132 for a leading edge of a media sheet 112 being fed onto the drum 100.

Two media control members 130b, 130c are in a second position beneath the cylindrical boundary 106 where they may each clamp a leading edge of a media sheet 112b, 112c (the remainder of the media sheets 112b, 112c may also be secured to the drum outer boundary 106 by either opposing contacting rollers or suitable vacuum drawn through openings spaced around the cylindrical boundary 106).

Finally, a fourth media control member 130d is in a third position projecting outwardly of the outer cylindrical boundary 106 to push the leading edge of the added sheet of media 112d away from the outer cylindrical boundary 106.

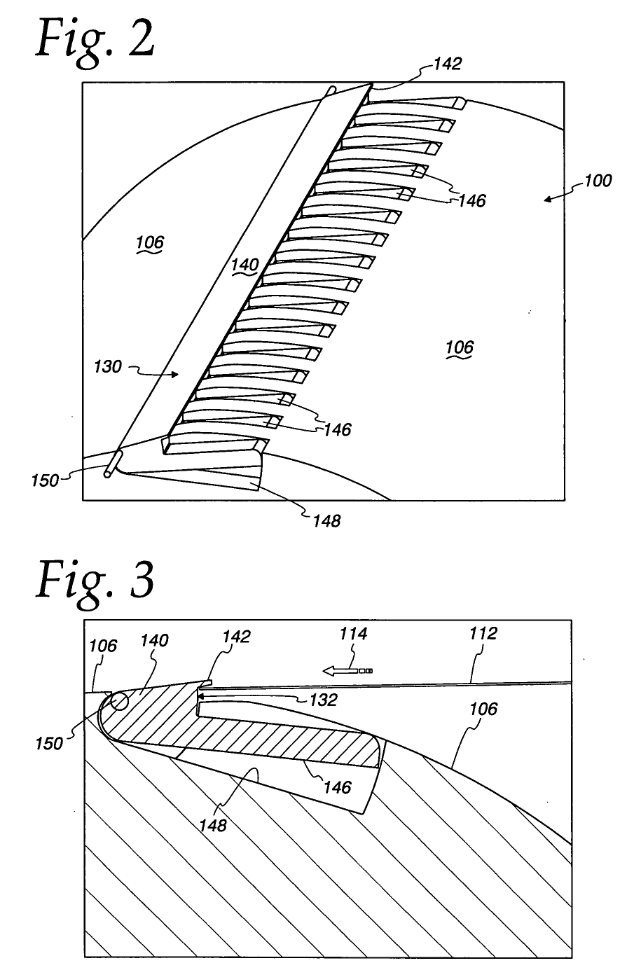

Referring now to FIG. 2, one of the media control members 130 is shown in the first position for adding a sheet of media to the drum 100. As best seen in FIG. 2, the media control member 130 extends laterally substantially parallel to the carrier drum axis 102, and includes a laterally extending base 140 with an lip 142 overlying the alignment barrier 132 and trailing legs 146 in slots 148 spaced across the width of the cylindrical boundary 106.

The base 140 is pivotable about a lateral axis 150 substantially parallel to the drum axis 102 and, in the first (media feed) position, the trailing legs 146 generally extend along chords of the cylindrical boundary 106 so as to be within (i.e., not extending beyond) the cylindrical boundary 106, while the base 140 projects up above the cylindrical boundary 106.

Thus, as best seen in FIG. 3, when the leading edge of a media sheet 112 is advanced onto the drum 100, it will engage the alignment barrier 132 (since, as previously noted, the media sheet 112 is advanced at a slightly greater rate of speed than the tangential speed of the cylindrical boundary 106). Such engagement will cause the leading edge of the media sheet 112 to therefore align precisely laterally on the drum 100.

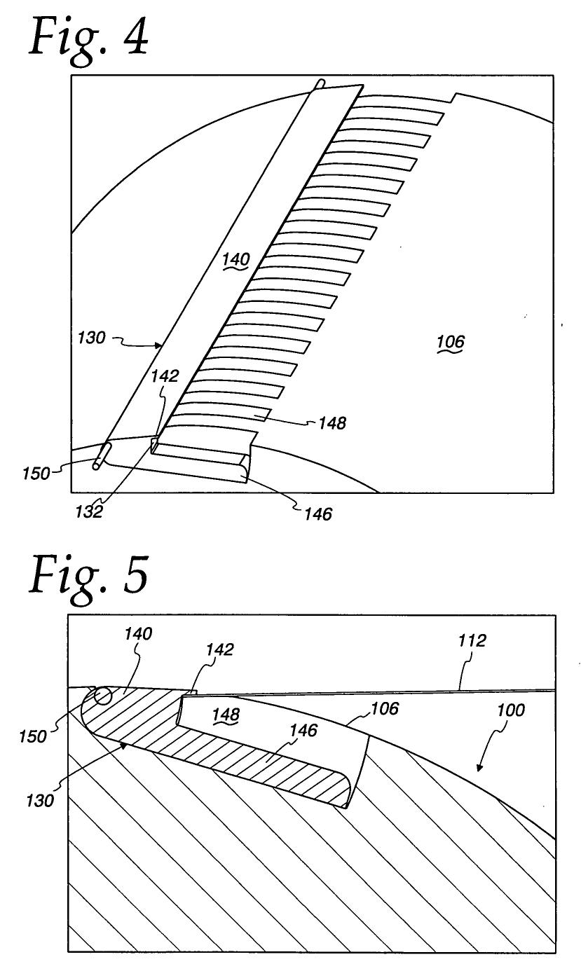

As the drum 100 and media sheet 112 advance further, the media control member 130 is pivoted down to the second position shown in FIGS. 4-5, where it clamps the leading edge of the media sheet 112 onto surfaces on the drum 100 between the slots 148 recessed beneath the cylindrical boundary 106. The media sheet 112 is thus in the desired aligned position on the drum 100 with its leading edge at a position slightly below the cylindrical boundary 106 of the drum 100 (and therefore the media control member 130 does not project beyond the cylindrical boundary 106 and potentially hinder proper printing).

Printing on the media sheet 112 can be made on the outer face of the sheet 112 secured on the drum 100, with the drum 100 rotating to move the sheet 112 through any print area (such as past an inkjet print head). Moreover, it should be appreciated that, by controlling the media feed 110 and take-away 120 and keeping the media control member 130 in the second position for more than 360° rotation, the media sheet 112 may be multi-pass printed if desired and/or required. Moreover, it should be appreciated that by providing four media control members 130a-d as illustrated in FIG. 1, spaced apart 90°, with a drum circumference which is more than four times the length of the selected media sheets to be printed, up to four different sheets may be in process at one time for printing on the drum 100. Still further, it should be appreciated that drums incorporating the present invention may be scaled to accommodate as many sheets as desired.

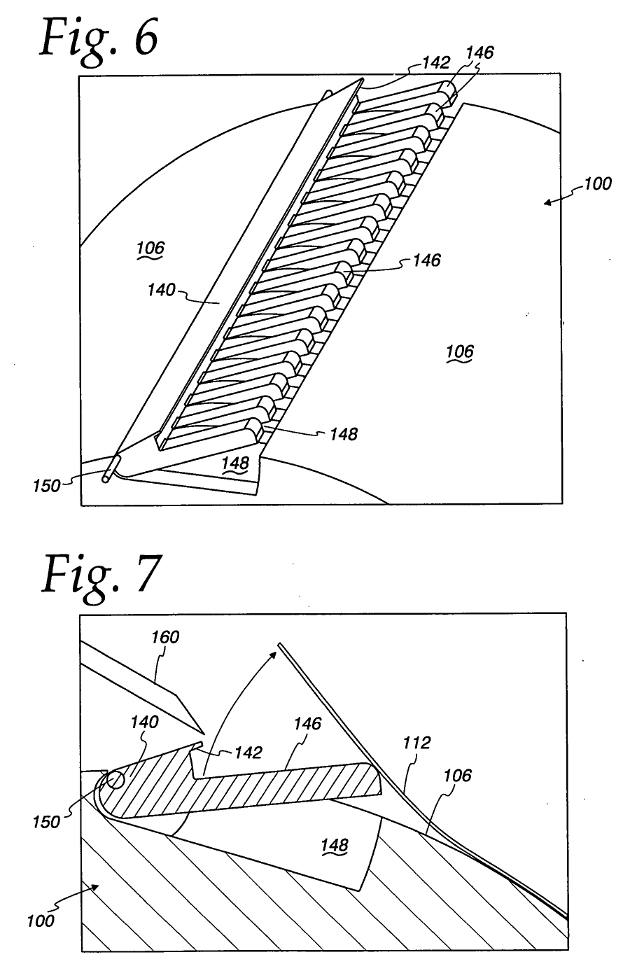

After printing of a sheet 112 is completed, the media control member 130 clamping the leading edge of the sheet 112 may be pivoted up to the third position as it approaches the take-away 120. In the third position shown in FIGS. 6-7, the lip 142 is raised so as to release the leading edge of the media sheet 112 from the drum 100, and the trailing legs 146 extend beyond the outer cylindrical boundary 106 to push the leading edge of the media sheet 112 away from the outer cylindrical boundary 106. As illustrated by the arrow in FIG. 7, the leading edge of the media sheet 112 moves away from the drum 100 through an arc which is clear of the media control member lip 142.

With the leading edge released as shown, as the drum rotates past the take-away 120, the media sheet 112 rides up over the rake 160 which is fixed adjacent the take-away 120 and directs the ejected media sheet 112 to the take-away 120.

Another embodiment incorporating various aspects of the present invention is illustrated in FIGS. 8-12, wherein the drum 200 is also rotatable about an axis about which the cylindrical boundary 206 of the drum is defined. This embodiment may be used such as the embodiment illustrated in FIG. 1, with a suitable media sheet feed and take-away with rake such as previously described. As previously described with the first described embodiment, with this second embodiment, each media sheet is fed so that the leading edge of the sheet travels at a rate of speed which is slightly higher than the tangential rate of speed of the drum 200 at its outer cylindrical boundary 206.

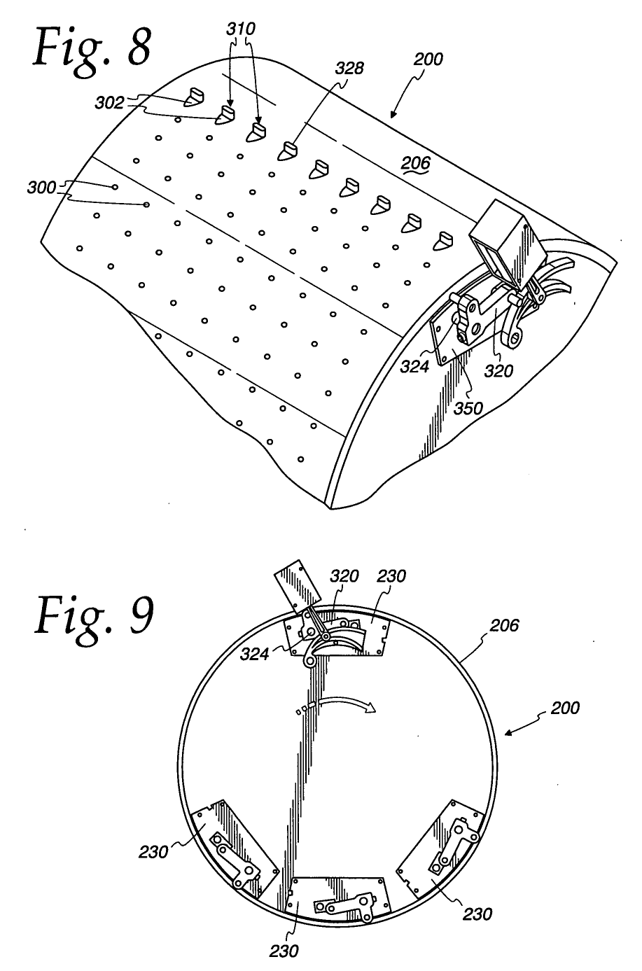

In the embodiment illustrated in FIG. 9, four media control members 230 are provided around the drum 200, with three of the media control members 230 spaced circumferentially apart substantially 120° around the print drum 230, whereby with a drum circumference which is more than three times the length of the selected media sheets to be printed, up to three different sheets may be in process at one time for printing on the drum 100. Moreover, by providing the fourth media control member 230 at 180° spacing from one of the other media control members 230, it should be appreciated that up to two media sheets of an even greater length may be handled at one time. Of course, as already noted, drums incorporating the present invention may be scaled to accommodate as many sheets as desired.

Vacuum openings 300 are also provided in the outer face of the drum 200, connected to a suitable vacuum source, to provide a hold-down force on the media sheets when applied thereto. Inasmuch as the leading edge of the media sheet is not clamped as with the first described embodiment (as detailed below), additional vacuum openings 302 are provided adjacent the media control members 230 to hold down the leading edge of the media sheet. Alternately, additional vacuum openings could be provided aligned with the leading edge but between the below described fingers 310 of the media control members 230. However, it should also be appreciated that the media sheets may be held to the drum outer face by configurations other than the vacuum openings 302 shown, such as electrostatic hold-down, capacitive hold-down, contact rollers, adhesive, and any other suitable device or combination of devices for holding the media sheets to the drum 200.

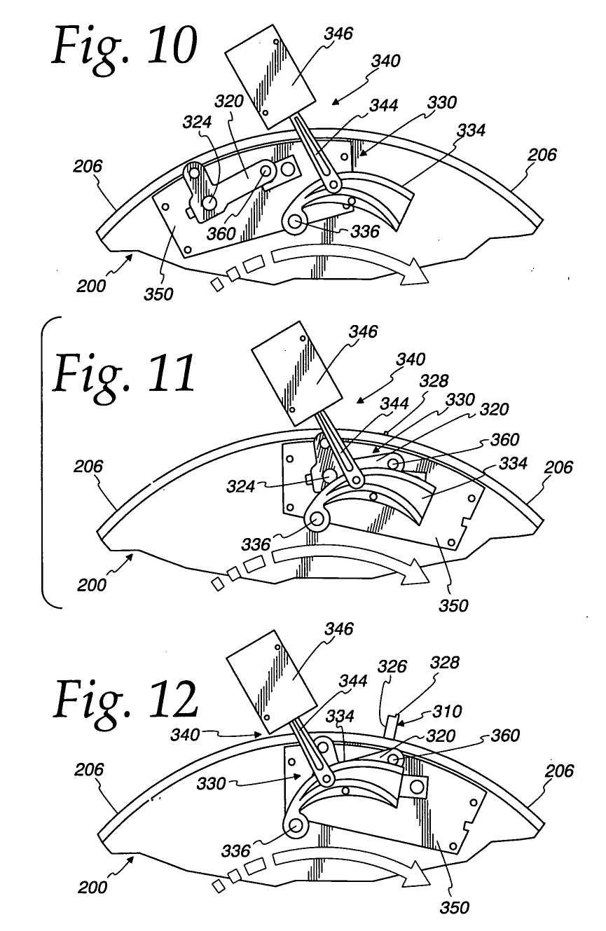

More specifically, each media control member 230 consists of a plurality of fingers 310 spaced laterally along the drum 200 and mounted for controlled radial movement between first, second and third positions, that is, a first position for aligning a media sheet being fed onto the drum 200 (FIG. 11), a second position in which the media sheet is secured on the drum 200 for printing (FIG. 10), and a third position in which the media sheet is pushed off the drum 200 for ejecting at the media take-away (FIG. 12).

The fingers 310 may be controlled for the generally radial movement between positions by an actuation lever 320 secured to a common shaft 324, with the fingers 310 being located at the end of arms spaced along the length of the laterally extending common shaft 324. With the arms inside the cylindrical boundary 306 in an orientation substantially like that of a chord in the boundary 306, pivoting of the common shaft 324 thus causes the fingers 310 to move substantially in a radial direction relative to the central axis of the drum 200. Alternatively, the fingers 310 could, for example, be secured to a fence member which is itself suitably secured to the common shaft 324 so as to move with pivoting of the shaft 324. Moreover, it should be appreciated that the fingers 310 may (either directly or through a fence member) be pivotally secured to the end of the arms extending from the common shaft 324, with the fingers 310 moving in a prismatic fashion (e.g., similar to an engine piston, with one end moving back and forth in an arc around the common shaft 324 and another portion reciprocating through a guide opening in the drum 200).

The fingers 310 of the media control member 230 each have a base portion 326 and a narrower radially outer end 328 (as best seen in FIG. 12).

An actuator 330 is illustrated for controlling the position of the media control members 230. The actuator 330 consists of an adjustable cam surface 334 which is pivotable about a pivot 336 at one end. An actuator drive 340 includes a control link 344 pivotally secured on one end to the cam surface 334 and secured on the other end to a suitable drive 346 which may be selectively controlled to move (e.g., push or pull) the link 344 to cause the actuator lever 320 of the media control member 230 to pivot. The pivot 336 and actuator drive 340 are fixed at a desired position (e.g., adjacent a media feed) and do not rotate with the drum 200.

The common shaft 324 of the media control member 230 may be advantageously biased so that the fingers 310 are biased toward their second position (i.e., entirely retracted inside the cylindrical boundary 206) as illustrated in FIG. 10. In this configuration, printing may be readily accomplished without hindrance by projecting portions of the media control member 230, and any media sheet on the drum 200 is secured by a vacuum drawn through the openings 300. With the cam surface 334 lowered as in FIG. 10, the media control member 230 may pass the cam surface 334 without changing position, thereby allowing additional revolutions of the drum 200 for multi-pass printing if desired.

It should be appreciated that the media control members 230 may be provided in housings 350 for convenient mounting in openings extending transversely behind the outer boundary 206 of the drum 200. With such configurations, individual drums may be provided with, for example, one, two, three or four (or more) media control members 230 such as previously described, depending on the intended use of the drum 200. Further, individual media control members 230 may be readily removed for repair and/or replacement if necessary during the life of the drum 200. Still further, such a housing 350 facilitates the placement of suitable gaskets (e.g., gaskets at each end of the housing 350 and around each finger 310) whereby a strong vacuum may be maintained in the openings 300 in the outer boundary 206 without undesirable leakage through the media control members 230.

If there is no media sheet on the drum 200 and the media control member 230 approaches the location of a media sheet feed (such as previously described) where it is desired to add a media sheet to the drum, the actuator 330 may be driven to pull the link 344 and cause the actuation lever 320 to pivot as a result of the cam member 360 on the actuation lever 320 sliding along the cam surface 334 as shown in FIG. 11 so that the radially outer ends 328 of the fingers 310 project above the cylindrical boundary 206 (i.e., the first position, shown in FIG. 11).

In that position (FIG. 11), the finger outer ends 328 will serve as an alignment barrier against which the leading edge of a media sheet will engage when fed onto the drum 200, and the media sheet will then be held on the drum 200 in a properly aligned orientation by vacuum through the vacuum openings 300.

Once the rotation of the drum 200 takes the media control member 230 beyond the actuator 340, the bias of the media control member 230 will move the fingers 310 back to the second position (i.e., completely inside the cylindrical boundary as shown in FIG. 10) where printing may continue. Moreover, it should be appreciated that the complete outer face of the media sheet will be exposed (without, e.g., any portion of the media control member 230 clamped over its leading edge), thereby allowing printing over the entire face of the sheet, including all the way to its leading edge.

It should also be appreciated that when a media sheet is secured to the drum 200, its leading edge will overlie the base portions 326 of the fingers 310. Thus, when printing of the media sheet is completed and it is desired to eject the sheet from the drum 200, the actuator 340 will be adjusted to pull link 344, and thus the cam surface 334, up to the third position shown in FIG. 12. In that position, the fingers 310 will extend up sufficiently so that the leading edge of the media sheet will be pushed away from the cylindrical boundary 206 of the drum 200, where a suitable rake such as previously described will direct the sheet away from the drum 200 to a suitable media sheet take-away.

An embodiment of the apparatus comprises a plurality of components such as one or more of electronic components, mechanical components, and/or hardware components. A number of such components can be combined or divided in an embodiment of the apparatus. In one or more exemplary embodiments, one or more features described herein in connection with one or more components and/or one or more parts thereof are applicable and/or extendible analogously to one or more other instances of the particular component and/or other components in the apparatus. In one or more exemplary embodiments, one or more features described herein in connection with one or more components and/or one or more parts thereof may be omitted from or modified in one or more other instances of the particular component and/or other components in the apparatus. An exemplary technical effect is one or more exemplary and/or desirable functions, approaches, and/or procedures. An embodiment of the apparatus comprises any (e.g., horizontal, oblique, angled, or vertical) orientation, with the description and figures herein illustrating an exemplary orientation of an exemplary embodiment of the apparatus, for explanatory purposes.

The steps or operations described herein are examples. There may be variations to these steps or operations without departing from the spirit of the invention. For example, the steps may be performed in a differing order, or steps may be added, deleted, or modified.

Although exemplary embodiment of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A print drum for carrying sheets of media, comprising:
a carrier drum generally defining an outer cylindrical boundary rotatable about its axis; and
a media control member including an alignment barrier and an ejecting portion, said control member mounted for selective movement between a retracted position inside said boundary and projecting positions for said alignment barrier and said ejecting portion, wherein in one projecting position said alignment barrier projects outside said boundary and said ejecting portion is inside said boundary.

2. The print drum of claim 1, further comprising an actuator for controlling the position of said media control member.

3. The print drum of claim 2, wherein said media control member may be maintained in said retracted position for more than 360° rotation of said carrier drum.

4. The print drum of claim 1, wherein said control member comprises a plurality of fingers spaced laterally along said carrier drum and mounted for controllable radial movement between said retracted position and projecting positions, said fingers each having a base portion and a narrow radially outer end extending from the base portion, wherein
in one projecting position, said fingers are positioned with said outer ends extending beyond the outer cylindrical boundary and said base portions within said outer cylindrical boundary whereby a leading edge of an added media sheet overlies said base portions,
in said retracted position, said fingers are positioned with said outer ends and said base portions within said outer cylindrical boundary, and
in a second projecting position, said fingers are positioned with said outer ends and said base portions extending beyond the outer cylindrical boundary and said base portions whereby a leading edge of an added media sheet is pushed out from said outer cylindrical boundary by said base portions.

5. The print drum of claim 1, wherein said control member comprises a laterally extending member pivotable about a lateral axis substantially parallel to said carrier drum axis, said control member having a lateral base with a lip and trailing legs, wherein
in one projecting position said lip extends beyond said carrier drum boundary to define the lateral alignment barrier and said trailing legs are within said outer cylindrical boundary,
in said retracted position, said lip and trailing legs are pivoted down within said outer cylindrical boundary, and
in a second projecting position, said trailing legs extend beyond said outer cylindrical boundary to push the leading edge of said added sheet of media away from said outer cylindrical boundary.

6. The print drum of claim 5, wherein in said retracted position, said control member lip clamps the leading edge of an added media sheet to said carrier drum, and in said second projecting position, said control member lip releases the leading edge of an added sheet.

7. A print drum for carrying sheets of media, comprising:
a carrier drum generally defining an outer cylindrical boundary rotatable about its axis;
a first media control member controllably movable between
a first position defining a lateral alignment barrier for a leading edge of a media sheet when adding said media sheet to said carrier drum,
a second position beneath said outer cylindrical boundary when printing on said added media sheet, and
a third position pushing the leading edge of said added sheet of media away from said outer cylindrical boundary.

8. The print drum of claim 7, wherein said first media control member may be maintained in said second position for more than 3600 rotation of said carrier drum.

9. The print drum of claim 7, further comprising a second media control member controllably movable between:
a first position extending beyond said carrier drum boundary to define a lateral alignment barrier for a leading edge of a media sheet when adding said media sheet to said carrier drum,
a second position beneath said outer cylindrical boundary when printing on said added media sheet, and
a third position projecting outwardly of said outer cylindrical boundary to push the leading edge of said added sheet of media away from said outer cylindrical boundary.

10. The print drum of claim 9, wherein said second media control member is circumferentially spaced from said first media control member by a circumferential distance which is greater than the length of at least one media sheet printed using the print drum.

11. The print drum of claim 9, wherein said media control members each comprise a plurality of fingers spaced laterally along said carrier drum and mounted for controllable radial movement between said first, second and third positions, said fingers each having a base portion and a narrow radially outer end extending from the base portion, wherein
in said first position, said fingers are positioned with said outer ends extending beyond the outer cylindrical boundary and said base portions within said outer cylindrical boundary whereby a leading edge of an added media sheet overlies said base portions,
in said second position, said fingers are positioned with said outer ends and said base portions within said outer cylindrical boundary, and
in said third position, said fingers are positioned with said outer ends and said base portions extending beyond the outer cylindrical boundary and said base portions whereby a leading edge of an added media sheet is pushed out from said outer cylindrical boundary by said base portions.

12. The print drum of claim 9, wherein said media control members each comprise a laterally extending member pivotable about a lateral axis substantially parallel to said carrier drum axis, said first control member having a lateral base with a lip and trailing legs, wherein
in said first position said lip extends beyond said carrier drum boundary to define the lateral alignment barrier and said trailing legs are within said outer cylindrical boundary,
in said second position, said lip and trailing legs are pivoted down within said outer cylindrical boundary, and
in said third position, said trailing legs extend beyond said outer cylindrical boundary to push the leading edge of said added sheet of media away from said outer cylindrical boundary.

13. The print drum of claim 12, wherein for each media control member, in said second position said lip clamps the leading edge of an added media sheet to said carrier drum, and in said third position said lip releases the leading edge of an added sheet.

14. A method of printing media sheets, comprising the steps of:
continuously rotating a drum about its axis;
selectively projecting a control member with an alignment barrier from the drum surface;
retracting the control member when a media sheet is aligned by engagement with the barrier and securing the media sheet on the drum;
printing on said media sheet while said control member is retracted;
projecting said control member to push the leading edge of said media sheet away from said drum; and
raking said media sheet off of said drum.

15. The method of claim 14, further comprising adding a media sheet to the drum by advancing a media sheet toward said drum in a generally tangential direction at a rate greater than the tangential speed of the drum surface.

16. The method of claim 14, further comprising rotating said carrier drum more than 360° with a selected sheet of media on said carrier drum to multipass print on said selected sheet of media.

17. The method of claim 14, wherein said selectively projecting, retracting, and moving steps comprise pivoting said media control member between first, second and third positions respectively.

18. The method of claim 17, wherein in said second position achieved in said retracting step, said media control member clamps a leading edge of an aligned media sheet to said carrier drum.

19. The method of claim 14, wherein said selectively projecting, retracting, and moving steps comprise radially moving said media control member between first, second and third positions respectively.
